(19) United States
(12) Patent Application Publication
(10) Pub. No.: US 2004/0115302 A1
(43) Pub. Date: Jun. 17, 2004

(54) Device and method for handling molded articles

(75) Inventors: Luc Rommes, Eischen (LU); James Rodrigues, Caledon (CA); Derek Kent William Smith, Richmond Hill (CA)

Correspondence Address: HUSKY INJECTION MOLDING SYSTEMS, LTD, CO/AMC INTELLECTUAL PROPERTY GRP, 500 QUEEN ST. SOUTH, BOLTON, ON, L7E 5S5, CA

(73) Assignee: Husky Injection Molding Systems LTD

(21) Appl. No.: 10/442,505

(22) Filed: May 21, 2003

Related U.S. Application Data
(63) Continuation-in-part of application No. 10/319,075, filed on Dec. 13, 2002.

(51) Int. Cl. B29C 31/08; B29C 49/64

(52) U.S. Cl. 425/526; 425/534; 425/547

(57) ABSTRACT

A multi-function take-out plate for use in an injection molding system. The take-out plate comprises a plurality of holders and a plurality of selectively engagable adhesion points coupled to the take-out plate. Each of the holders is arranged to receive a molded article formed in and extracted from a respective cavity of a mold. The adhesion points are configured to pick up and temporarily hold linear arrays of molded articles for subsequent delivery and deposition. In a preferred embodiment, the plurality of holders have a pitch separation corresponding to the pitch separation of the mold from which the molded articles are extracted. The adhesion points are arranged in an array such that the pitch separation of adjacent molded articles held by the adhesion points is less than the pitch separation in the mold.

### BACKGROUND OF INVENTION

1. Field of the Invention

The present invention relates, in general, to a handling device and a method for handling elongate molded articles, and is particularly, but not exclusively, applicable to a multi-function take-out plate for handling large injection molded preforms, e.g. elongate preforms that are subsequently blow-molded into 10 to 25-liter water bottles.

2. Background Information

To date, there has been a tendency for large beverage containers and the like, e.g. the aforesaid 10 to 25-liter water bottles, to be manufactured in polycarbonate in an extrusion-blow manufacturing process. Polycarbonate is however relatively soft and therefore susceptible to surface damage, e.g. scratching, and its manufacturing process is generally costly.

Recently there has been a general movement and desire to produce such large containers in polyethylene tetraphthalate (PET), especially since the processing of PET can be performed in an injection molding environment and, besides increased ease of recycling of the molded article and increased resilience to scratching, the optical quality of PET injection molded articles is generally better than corresponding polycarbonate articles. Furthermore, the injection molding process also yields molded articles having repeatably attainable, highly-toleranced physical dimensions which therefore ensures enhanced part quality.

In the manufacture of injection molded articles, e.g. in the context of preforms for food and beverage applications and the like, an injection molding machine can support a mold with multiple mold cavities so that a number of articles can be molded in a single molding cycle. For large or heavyweight preforms, generally considered to weigh in excess of about 100 g and typically more, a mold configuration may be laid out as two columns of eight preforms. Large or heavyweight preforms often have lengths dimensions generally in excess of about 20 cm and diameters of about 5 cm. For smaller preforms, mold cavitation sizes are considerably smaller and accordingly the number of mold cavitations can be considerably larger, with manufacturers presently offering systems with up to 144 cavities. After the plastics melt has been injected into the mold cavities, the mold must remain shut, to allow sufficient solidification of the melt into the article to allow handling of the article without causing meaningful deformation.

The number of preforms formed in an injection molding cycle depends on the number,of injection mold cavities, with the number of cavities also dependent upon the plastic volume throughput per cycle of the extruder and injection unit. For very heavyweight preforms, e.g. preforms for 10 to 25-liter bottles, injection molding machines typically support cavitations of between about 1 to 8 cavities, although other cavitations are possible, subject to machine tonnage, extruder throughput and cycle time. The cavities, for optimized cooling purposes, are generally aligned in parallel columns of cavities, with all cavities in adjacent columns also aligned in a horizontal plane to form a symmetrical rectangular array. Of course, adjacent parallel columns could have their respective cavities offset or staggered, or there may simply be a single column/row of cavities.

The cycle time of such an injection molding process varies according to the size of the molded article being manufactured, with smaller articles, e.g. preforms suitable for blowing into 500 ml bottles, requiring less time to inject and sufficiently solidify than larger articles, such as preforms designed to be blown into 10 to 25-liter water bottles, which can have preforms weights of about 500 g to 700 g, although larger (heavier) preforms are also being considered. Essentially, the cycle time is related to the mass and thermal dissipation characteristics of the molded article, with thicker preforms having better insulative properties arising from the poor thermal transfer characteristics of plastics, particularly PET and PEN (polyethylene naphthalate). Once the articles have solidified sufficiently to allow handling, the mold is opened and the articles are ejected from the mold. U.S. Pat. No. 4,690,633 describes the use of intimate fit cooling tubes for removing molded articles, such as preforms, from the mold and delivering them to a conveyor system.

Generally, the articles are dropped from the injection mold or the cooling tubes onto a conveyor, which then transports the articles and drops them into a shipping crate. It has, however, been noted that, when the articles are ejected from the cooling tubes, they are prone to damage and deformation; this is particularly true for larger articles such as preforms for 10 to 25-liter water bottles. Damage, such as surface scratching, can also occur and be accentuated when the articles are loaded into shipping crates or the like. Furthermore, from a logistical movement perspective, it is desirable to load the molded articles into shipping crates in an efficient and compact way to optimize the number of articles in each crate. As exemplified in U.S. Pat. No. 5,555,706 wherein a method and apparatus is disclosed for arranging a plurality of performs into an array of predetermined size and shape. The preforms in the array are arranged in a plurality of side-by-side horizontally extending rows in which the preforms are upright and in a “threads up” orientation. Alternate rows of the preforms are picked up and inverted so that they are in a “threads down” orientation. The remaining rows are then picked up and positioned in an alternating relationship with the “threads down” rows of preforms, so that multiple layers of preforms can be stacked in a container so as to fully use all of the space in the container for storage and transfer of the preforms.

Typical preform handling systems have the common function of minimizing production cycle time while preserving preform quality. An important example of such an improvement can be found in U.S. Pat. No. Re. 33,237 that discloses a take-out plate that cooperates with an injection molding machine for handling and temperature conditioning multiple shots of performs. The take-out plate significantly reduces the required amount of in-mold cooling time and thereby reduces the production cycle time.

In view of the foregoing, it is desirable to extend the functionality of known preform handling systems to be further capable of integrating and/or executing auxiliary processes such as preform packing into containers.

### SUMMARY OF INVENTION

In a first aspect of the present invention there is provided a multi-function take-out plate that comprises: a plurality of holders each arranged, in use, to receive a molded article formed in and extracted from a respective cavity of a mold; and a plurality of selectively engagable adhesion points arranged along the take-out plate, the adhesion points configured, in use, to pick up and temporarily hold linear arrays of molded articles for subsequent delivery and deposition. In a preferred embodiment, the plurality of holders have a first pitch separation corresponding to a first pitch separation from the mold from which, in use, the molded articles would be extracted; and the adhesion points arranged in an array that causes, in use, molded articles held by the adhesion points to have a reduced pitch separation between adjacent injection molded articles relative to the first pitch separation in the mold. Alternatively, the adhesion points may be integrally formed suction ports formed in the base plate.

In a second aspect of the present invention there is provided multi-function take-out plate that comprises a base plate having a first surface and a side surface, the first surface having located thereon a plurality of cooling tube connection points, each cooling tube connection point arranged, in use, to mount a cooling tube configured to receive a molded article; and at least one side plate coupled to the side surface of the base plate, the at least one side plate having at least one selectively engagable molded article adhesion point, the at least one adhesion point supporting, in use, pick up and temporarily retain a linear array of molded articles for subsequent delivery and deposition thereof. In a preferred embodiment, the plurality of cooling tube connection points are located such as to allow, in use, the cooling tubes to have a first pitch separation corresponding to a first pitch separation from a mold from which, in use, the molded articles would be extracted; and the at least one adhesion point arranged in an array that causes, in use, molded articles held at the adhesion points to have a reduced pitch separation between adjacent injection molded articles relative to the first pitch separation in the mold.

In a third aspect of the present invention there is provided a side panel for connecting to a take-out plate, the side panel including at least one selectively engagable adhesion point, the at least one adhesion point configured, in use, to pick up and temporarily hold at least one molded article for subsequent delivery and deposition. In a preferred embodiment, the at least one adhesion point are arranged in an array that causes, in use, molded articles held by the at least one adhesion point have a reduced pitch separation between adjacent injection molded articles relative to a pitch separation of the molded article within a mold.

The handling device allows the safe handling of articles, in particular of large injection molded preforms. The articles are carefully placed, aligned and orientated such that they are positioned in a linear array of articles arranged in opposite directions. The pitch separation between adjacent articles can be reduced or eliminated. The aligned and orientated articles can then be carefully transported to a shipping crate or the like. Damage to the articles through rough handling, e.g. dropping of the articles onto a conveyor, is avoided. Furthermore, a closer packaging arrangement allows a more efficient packaging of the articles.

The handling device of present invention can also comprise a robot for transferring the articles from a mold of the molding machine to the receiving plates. Such a robot can comprise a take-out plate for receiving the articles from a mold and a robot arm for operating the take-out plate so as to transfer the articles from the mold onto the first and second receiving plates. The robot arm preferably has six degrees of freedom. Such a robot arm can move the take-out plate along any path between the injection mold and the handling device. It is thereby possible to avoid any obstacles that might be present.

### BRIEF DESCRIPTION OF DRAWINGS

Exemplary embodiments of the present invention will now be described with reference to the accompanying drawings, in which:

FIG. 1 is a schematic top view of an injection molding system arranged to package or crate-up articles according to a first embodiment of the invention;

FIG. 2 is a schematic view of a preferred configuration of a take-out plate that is operable in the injection molding system of FIG. 1;

FIG. 3 is a schematic top view of a handling device of a preferred embodiment of the present invention;

FIG. 4 is an intermediate processing station that can be used in FIG. 1 to facilitate preform orientation; and

FIGS. 5 to 11 are a sequence of illustrations of a robotic system constructed in accordance with a preferred embodiment of the present invention.

### DETAILED DESCRIPTION

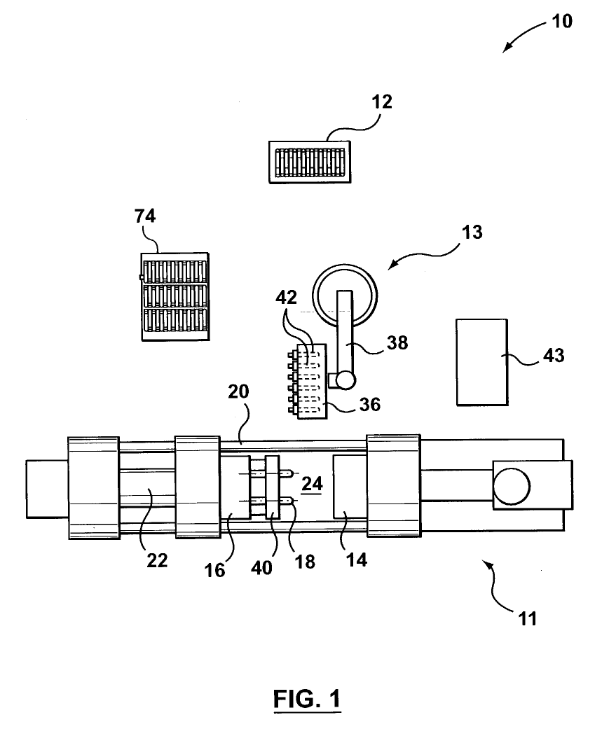

FIG. 1 shows an injection molding system 10 for producing and packing elongate molded articles and especially large-sized or heavyweight preforms produced by an injection molding machine 11. FIG. 1 shows the injection molding machine 11 and a handling device comprising an arranging station 12 and a handling robot 13 for transferring the preforms from the injection molding machine 11 to the arranging station 12.

The injection molding machine 11 comprises a first mold half 14 with a plurality of cavities therein and a second mold half 16 with a plurality of elongate cores 18 thereon. The number of cores 18 on the second mold half 16 corresponds to the number of cavities in the first mold half 14. The first and second mold halves are mounted on respective platens which, during operation, are closed and clamped together under an applied tonnage clamp force, e.g. by co-operation of tie-bars 20 and a hydraulic cylinder 22. FIG. 1 shows the first and second mold halves 14, 16 in a mold-open position, wherein a gap 24, suitable to accommodate a take-out plate of a side or top entry handling robot 25, is formed between the mold halves 14, 16 held within their respective platens.

In the mold-closed position, the elongate cores 18 of the second mold half 16 engage in respective cavities of the first mold half 14 to form an injection mold cavity. Plastic material is injected into the injection mold cavity by known injection molding procedures. After injection of the plastic material, the mold portions 14, 16 remain in the mold-closed position until the plastic material has sufficiently solidified to allow handling of the preforms without causing meaningful deformation. The mold portions 14, 16 can then be moved into the mold-open position to allow removal of the preforms from the elongate cores 18 of the second mold half 16.

Referring back to FIG. 1, the handling robot 13 removes freshly molded preforms from the cores and delivers the removed preforms to an arranging station 12. The handling robot 13 comprises a take-out plate 36 mounted on a free end of a robot arm 38. The robot arm 38 is preferably configured to have six degrees of freedom to provide full movement capabilities for the take-out plate 36. The robot arm 38 can be implemented using, for example, linear actuators, although other drive mechanisms are possible. When the mold halves 14, 16 in the injection molding machine 10 are separated in the mold-open position, the robot arm 38 moves the take-out plate 36 into the gap 24 between the mold portions 14, 16 and positions the take-out plate 36 to receive a set of preforms from the mold portions 14, 16. The transfer of the preforms onto the take-out plate 36 is preferably accomplished by the use of a stripper plate 40 associated with the second mold half 16, which stripper plate physically engages and mechanically ejects the preforms form the cores, as will be understood.

The take-out plate 36 is preferably arranged to accentuate cooling of the preforms while they are being transported to the arranging station 12. The take-out plate 36, in a preferred embodiment, therefore comprises a set of water cooled cooling tubes 42, coupled to the take-out plate, for receiving the freshly molded preforms therein. Such water-cooled and/or intimate fit cooling or take-out tubes 42 are described in U.S. Pat. No. 4,729,732 (incorporated by reference herein). Alternatively, to reduce weight of the take-out plate, the take-out tubes 42 could be realized as holders having a basic skeletal structure conforming to the shape and size of the ejected preform.

Preferably, as discussed in European patent EP 0 283 644 (the disclosure of which is hereby incorporated by reference), the take-out plate 36 comprises at least two sets of cooling tubes 42 such that the number of cooling tubes 42 in the take-out plate 36 corresponds to an integer multiple of at least twice the arrangement of cavities of first mold half 14.

With the use of a multi-axis robot, molded articles retained temporarily in the take-out plate 36 can be maneuvered and hence delivered to, or positioned relative to, one or more intermediate processing stations, or post-mold processing stations. FIG. 1 illustrates (for reasons of clarity only) only one such intermediate processing station 43 which, for the sake of explanation, is an intermediate cooling station. It will be appreciated and understood that a variety of complementary or different intermediate processing stations can be stacked or other proximately located relative to the illustrated intermediate processing station 43.

For example, the intermediate processing station 43 can comprise a multiplicity of upstanding pins on one or more racks. Preferably, in such an arrangement, each rack of pins would contain a sufficient number of pins to allow the deposition of at least two rows of preforms (in successive placement operations) from corresponding rows in the take-out plate. Each pin is preferably operable to express a cooling fluid from its tip (fed by an internal channel coupled, in use, to a supply of cooling fluid, e.g. compresses air). If, as in a preferred embodiment, there are a plurality of racks of pins, then these racks are mechanically sequenced to allow preforms positioned on the pins to benefit from an extended cooling cycle attributable to the duration of the service cycle for each rack. Also, by having the cooling pins located independently of the robot per se, the weight of the robot is reduced. Of course, either the rack or the robot could be mechanized to access each rack in the system, although it is preferable that the racks remain stationary and the robot (instead) programmed to present and subsequently off-load preforms from each rack according to a programmed sequence. Preferably, with the ability of the take-out plate 36 to retain performs for at least the majority of one molding cycle and preferably more than one cycle, the system of the present invention can attain cycle time benefits over existing systems since the efficiency of scheduling that results from use of a multi-axis robot permits the simultaneous or seemingly contiguous execution of different tasks with respect to either different sets of performs held by the take-out plate 43 in one specific set of performs (i.e. mold articles) held by or delivered by the take-out plate 43. The handling flexibility provided by the multi-axis robot 13 generally therefore provides cycle time benefits. Additionally, overall part quality can be improved in instances where the molded article undergoes intermediate or post-mold processing (e.g. aggressive cooling), especially since physical hand-off of the molded article from the take-out plate can be avoided. For example, extended retention of the perform in a take-off holder (e.g. cooling tube 42) eliminates a potential for deformation arising from any hot surface contact (of or between molded articles), which hot surface otherwise generally develops over time by heat migration from the inside of the wall of the plastic molded article to an outside surface thereof. Additional cooling offered by the preferred system of the present invention also reduces physical damage, e.g. scratching, to the preform itself.

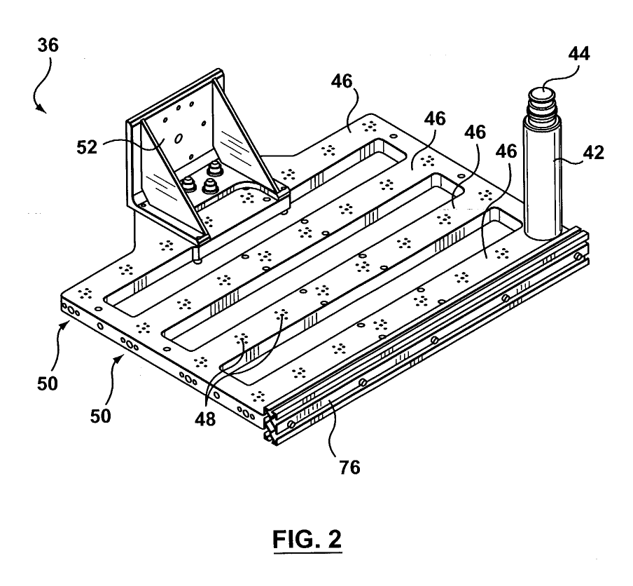

A schematic view of such a take-out plate 36 is represented in FIG. 2. For the sake of clarity, only one of the cooling tubes 42, with a preform 44 received therein, is represented in FIG. 2. The take-out plate 36 comprises, in this exemplary configuration, four columns 46 of connections 48, each column 46 having eight connections 48 for cooling tubes. With the use of a multi-position take-out plate, the connections 48 are arranged in multiple corresponding arrays corresponding in orientation and configuration to the layout of the cavities in the first mold half 14. Considering a two-position take-out plate 36, at the end of each injection cycle, the preforms 44 produced in that cycle are ejected from the cores and received into the cooling tubes 42 of a designated empty set of cooling tubes, while the preforms 44 formed in the previous injection cycle are still retained in the cooling tubes 42 of an earlier utilized set of cooling tubes. The preforms 44 formed in the earlier injection cycle are placed on the arranging station 12 (to be described in detail subsequently) before the end of the next injection cycle, so that the preforms 44 formed in the next injection cycle can be received in the cooling tubes 42 of the now empty set of tubes. This allows for the preforms 44 to be cooled by the cooling tubes for an extended time to improve overall machine cycle time. A connection plate 52 is provided on the take-out plate 36 for connecting the latter to the robot arm 38.

The arranging station 12 and the intermediate processing station 43 may be realized separately or may be one and the same.

The take-out plate 36 of the present invention is configured as a multi-function plate. As already discussed, the take-out plate 36 firstly acts as a preform removal system to receive preforms ejected from the cores 18 into take-out tubes 42 or holders. To this extend, a first surface of the take-out plate 36 supports the mounting of the take-out tubes 42. In the event that the take-out plate 36 or tubes 42 are fluid cooled, then the take-out plate 36 is channeled to accommodate the supply of cooling fluids; this requires that the take-out plate 36 contains a suitable supply port interface 50. A further function of the take-out plate 36 of the present invention relates to a packing function complementary to the operation of the arranging station 12. The take-out plate of the present invention includes an array of pick-up holders or adhesion points such as suction pads 76 that, in FIG. 2, are shown on a side end of take-out plate 36 in an orientation perpendicular to the major axis of the cooling tubes 42. The array of suction pads 76 may be realized as individual cups or as strips of elastomeric material that facilitates the production of a good seal between each pad, cup or strip and preforms that are both to be engaged by the suction pad, cup or array and subsequently moved, under suction/vacuum, by the handling robot 13 to a different position. The array of suction pads can be located on any suitable surface, e.g. the parallel underside surface to the take-out tubes 42, of the take-out plate 36. The take-out plate 36 is therefore also configured (e.g. channeled) to support interconnection of a vacuum supply to the array of suction pads 76, which vacuum supply (not shown) is connected through the supply port interface 50, or any another dedicated connection path. Alternatively, the adhesion points 76 may be integrally formed suction ports formed through a surface of the base plate that are controllably connected to a vacuum source.

As will be understood, preforms are preferably retained in the take-out tubes 42 under suction, with a closed end of each take-out tube 42 connected to the supply port interface via the respective connections 48.

Of course, the array of suction cups could be located on the robot arm 38 per se, rather than on the take-off plate 36.

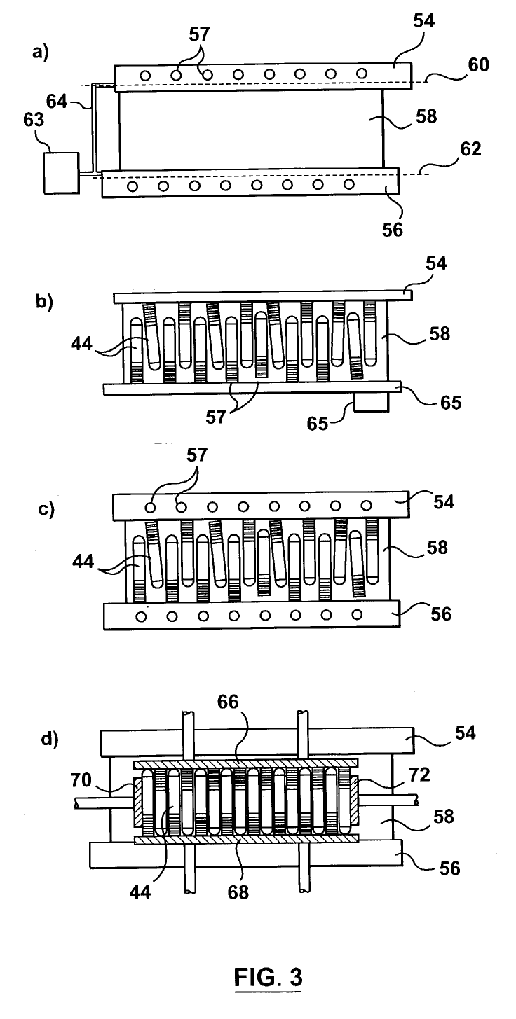

A top view of the arranging station 12, to which the preforms 44 are delivered by the take-out plate 36, is illustrated in FIG. 3.

FIG. 3a shows a first longitudinal receiving plate 54, a second longitudinal receiving plate 56 and a support table 58. The first receiving plate 54 and the second receiving plate 56 each have a pivot axis 60, 62 that are substantially parallel to one another. Each receiving plate 54, 56 comprises holders 57, e.g. in the form of pegs or mandrels or recessed cavities, for receiving the open ends of the preforms 44 and initially maintaining them in an upstanding fashion on the receiving plates 54, 56.

By axial re-orientation of the robot arm 38, the preforms 44 are aligned and then placed, essentially upright, with their open ends onto respective holders 57 of the receiving plates 54, 56. Release from the take-out plate 36 can then take place by removing the vacuum and retracting the take-out plate 36. If the preforms on the first receiving plate 54 are not already in a staggered relationship to the preforms 44 on the second receiving plate 56, the first and/or second receiving plates 54, 56 are, in a first embodiment, displaced longitudinally until the preforms are in a staggered relationship; this linear displacement can be accomplished by a rack and pinion driven by a drive unit, such as an electric motor or hydraulic motor. Alternatively, the robot arm 38 can operate to place the preforms 44 on the respective receiving plates 54, 56 in successive movements whereby the set of preforms 44 to be handled are essentially split into two or more groups corresponding to the layouts of the receiving plates 54, 56.

Once the preforms 44 are staggered or interlaced between adjacent receiving plates 54, 56, an actuator 63, such as an electric motor, is then operated to rotate gently the first and second receiving plates 54, 56 about their pivotal axis 60, 62 until the preforms on the first receiving plate 54 and the preforms on the second receiving plate 56 are horizontally arranged side-by-side on support means 58, as shown in FIG. 3b. An actuator may be associated with each receiving plate, alternatively a mechanical linkage 64 may communicate a rotational instruction between adjacent receiving plates. In this way, the actuator 63 causes the tops and bottoms of adjacent preforms to lie side-by-side. The support means for supporting the preforms after they have been released from the holders 57 can e.g. be a support table 58 or support bars. It is to be noted that the use of such support means is not a necessity; it is e.g. possible for the handling robot 13 to place the suction cups 76 of the take-out plate 36 so as to engage the preforms before the latter are released from the holders 57.

After the preforms have been laid down on the support table 58, the preforms are released from the holders 57. In a preferred embodiment, the release mechanism is a motor 65 that operates to retract the pegs into the receiving plates 54, 56, thereby subsequently allowing free movement of the preforms. Alternatively, a pusher bar can be provided for pushing the preforms off the pegs. After the preforms have been released from the holders 57 of the receiving plates 54, 56, the receiving plates 54, 56 can be rotated back into their starting position, as shown in FIG. 3c, to receive the next set of preforms from the take-out plate 36.

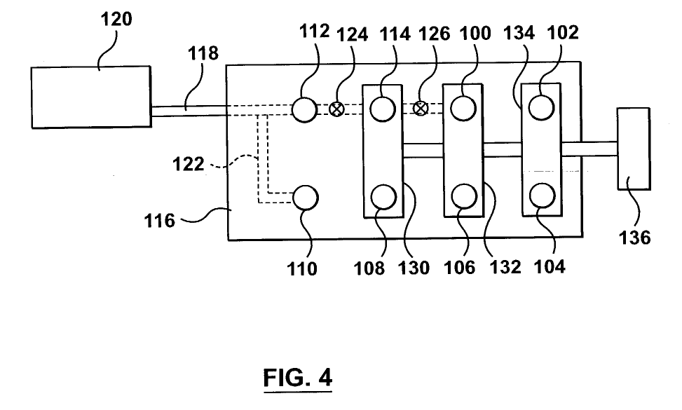

The arranging station 12 further comprises alignment means 66, 68, 70, 72 for aligning and/or bringing together the preforms 44 after they have been released from the holders 57 of the receiving plates 54, 56. Such alignment means are shown in FIG. 4d and can comprise a pair of pusher bars 66, 68 for aligning the preforms in their longitudinal direction and a pair of pusher bars 70, 72 for aligning the preforms in their transverse direction. The longitudinal pusher bars 66, 68 may function as release mechanism that removes the preforms 44 from their holders 57. The pusher bars 66, 68, 70, 72 act to bring the preforms closer together and to optimize packing of the preforms top-to-bottom. While the preferred embodiment utilizes two parallel pushers, it will be appreciated that the system could work equally well provided that relative linear movement occurred between a pusher and a fixed (but rotatable) receiving plate. Equally, the same relative movement is all that is necessary for transverse compression of the preform spacing to remove the gaps between adjacent top-to-toe preforms. Once the preforms 44 have been brought into a position as shown in FIG. 3d, they can be transported from the arranging station 12 to a shipping crate 74 or the like. In this respect, the robot arm 38 is once again used. Specifically, the robot arm 38 re-orientates the multi-function take-out plate 36 such that the array of suction pads 76 are aligned above and then brought into contact with the preforms to engage, under suction, and lift the preforms to the designated shipping crate 74 or the like, e.g. an ancillary collection table or conveyor system. With the preforms initially closely aligned by the pushers, or their function equivalent, of the arranging station, the multi-function take-out plate is able to maintain this desirable tight and efficient packing as the preforms are packed in the crate. Also, beneficially, the use of the handling robot 13 in the packing process ensures that the preforms are placed, rather than dropped, and hence the likelihood of damage to heavyweight preforms is substantially reduced.

In another embodiment, the arranging station of FIGS. 1 and 3 can be substituted by an equivalent functional configuration as shown in FIG. 4, which functional configuration can, in fact, be integrated into or otherwise separate from an intermediate cooling station. Specifically, with reference to FIG. 4, the handling device 12 is now realized by an array of pins 100-114 on a plate 116. The pins are preferably hollow and support the expulsion of cooling fluid from their respective tips. Hence, the plate 116 may be, as appropriate, connected through piping 118 to a switchable cooling fluid supply/vacuum supply 120. Typically, the cooling fluid supply is pressurized, chilled air or the like. In the exemplary array of pins, eight pins are shown. Each of the pins 100-114 is coupled to the air supply/vacuum supply 120 by ducting or tubing 122 that may include strategically located valves 124-126 (only two of which are shown) to allow for the vacuum or pressurized cooling fluid supply to be selectively connected to each hollow pin 100-114.

The array of pins (in each row and/or between rows) preferably corresponds in layout to the pitch of the cavities of the mold and hence also the layout of the cooling tubes 42. In this way, the take-out plate 36 and robot 13 can operate to deliver all formed preforms onto respectively aligned pins in a one-step process.

In operation, once the preforms are aligned with the respective pins 100-114 (but when the preforms are still retained in their respective take-out tubes 42), the air supply 120 is switched to provide a pressurized stream of cooling fluid into the preforms. For maximum cooling benefit, the pins are introduced into the respective preforms such that cooling fluid can be directed onto internal surfaces of the preform and, most preferably, onto surfaces that are relatively hot and/or which are usually subject to crystallinity problems, e.g. the gate region. Cooling fluid is then allowed to vent from the neck-opening of the preform since the system is preferably an open-system in which the interior of the perform is in direct fluid communication with an ambient environment. With sufficient interior cooling accomplished, the air supply is terminated by the switch energized to engage the vacuum or suction circuit, thereby drawing the performs from the take-out tubes onto the pins 100-114.

With the performs retained on the pins 100-114, the robot 13 can now reposition itself to align its suction pads 76 (shown in FIG. 2) with the performs to withdraw (following curtailment of the vacuum/suction force through the hollow pins that would otherwise retain the preform on the pins 100-114) a first group of performs (not being all the performs). Re-orientation of the robot's arm then permits all remaining preforms to be withdrawn on the suction pads 76. More specifically, the operation of re-orientation allows for preforms from the two aforementioned groups to be orientated head-to-toe (or top-to-bottom) relative to each other. In order that optimum packing can now be performed, a slide mechanism co-operating with the suction pads 76 brings the performs into close contact, thereby removing the pitch separation introduced between preforms during the molding cycle. It will be understood that the slide mechanism can be indexed or geared to ensure optimum space suppression between adjacent preforms. The slide can be realized, for example, by a hydraulic, pneumatic or piston-operated activation device, as will be readily appreciated.

Alternatively, to avoid increasing the weight of the take-out plate 36, the pins 100-114 can be mounted on slides 130-134 that are responsive to an actuator 136, thereby causing (in a group selective basis) specific slides to move together. In operation, slide compression will generally operate at least once during one cycle. In other words, there is relative movement between the array of pins 100-114 that reduces center-line displacement between preforms, with the robot controlled to initially remove a first number of preforms and then to be re-orientated through 180° to permit the removal of the remaining preforms into designated suction cups 76, e.g. alternately spaced suction cups not currently holding a preform.

It is also contemplated that in order to avoid the use of a relatively complex slide and actuation arrangement, strict suction control could be applied to both the array of pins 100-114 and the suction pads 76 on the take-out plate. In this way, the robot arm and specifically its suction pads pick selected preforms from pins 100-114, whereafter the robot re-positions the take-out plate 36 to suppress center-line displacement between preforms held on the suction pads 76 of the multi-function take-out plate, and then to pick other perform(s) from the respective pins 100-114. As necessary, the robots also undergoes 180° inversion to cause close top-to-bottom alignment of the performs along the length of the side of the take-out plate supporting the suction pads 76. Over time, therefore, the suction pads are filled with appropriated spaced, appropriated aligned and appropriated orientated preforms, which preforms can then be placed, preferably by the robot 13, into a crate for shipping in a logistically optimized fashion.

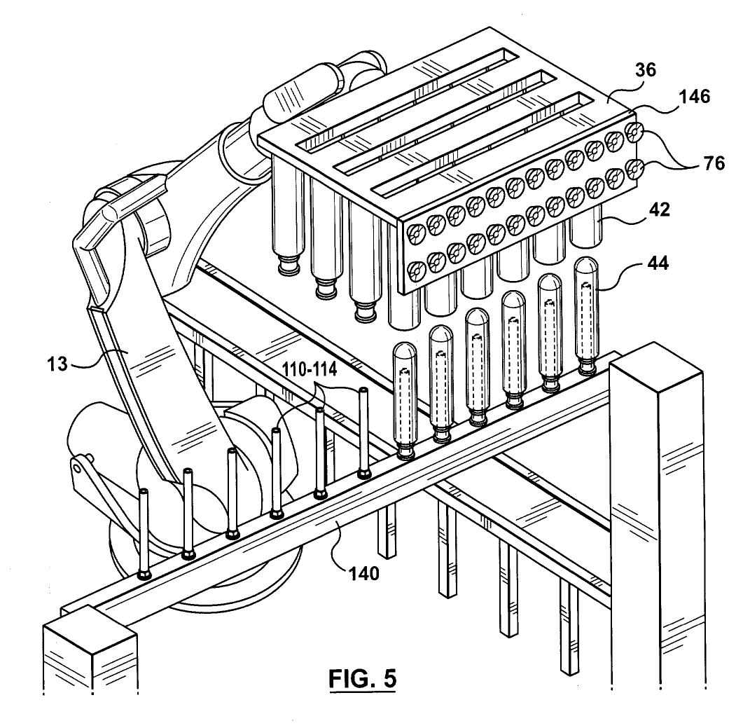

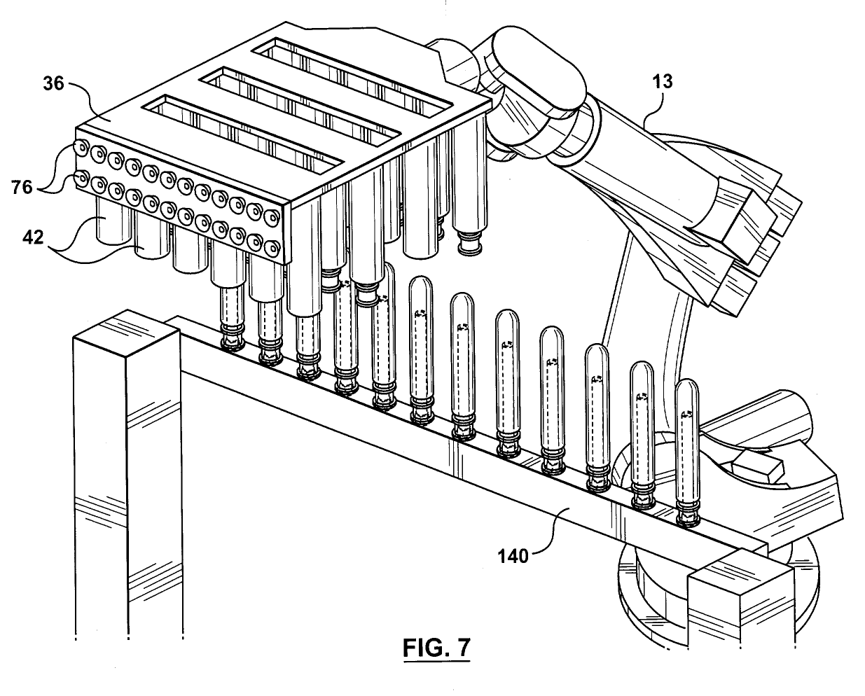

In other words, once the preforms are removed from the take-out plate and positioned on the array of pins 100-114, the robot is operable to re-positioned itself to support the pick-up of preforms onto a first set of suction cups (or the like). Thereafter, the robot's position and typically also its orientation is again changed to allow a second set of preforms to be aligned with and picked up by a second set of suction cups (or the like). This configuration therefore has an inherent natural tendency to suppress (as far as practical or as desired) the pitch between preforms as originally defined by the mold's layout. The effect of the location and function of the suction cups (or the like) is therefore to align closely the preforms on the multi-function take-out plate 36; this is best illustrated in relation to FIGS. 5 to 11.

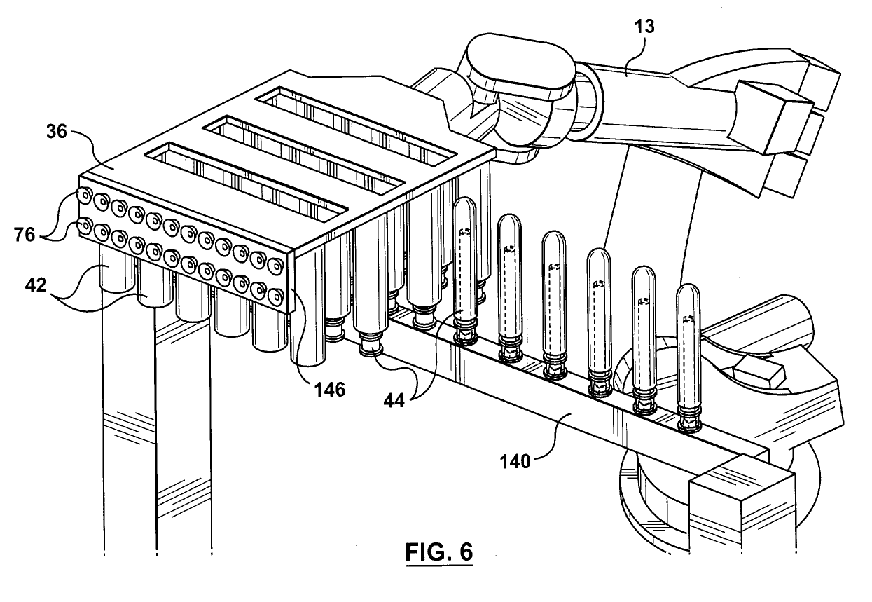

Turning to FIGS. 5 to 11, a particular embodiment of the present invention is shown (in a variety of process steps). In FIG. 5, the take-out plate 36 has received preforms from at least one molding cycle, which preforms are held (under vacuum) in cooling tubes 42 or their functional equivalent. More specifically, the robot has orientated the preforms (and tubes) such as to allow delivery of the preforms 44 to a rack 140 of pins 110-114. In the specific case of FIG. 5, a first row of preforms has been deposited on a first set of upstanding pins on the rack, whereas in FIG. 6 a second row of preforms has been deposited following movement of the robot's arm. The deposition of preforms in FIGS. 5 to 7 represent, preferably, processing (and alignment) of a single set of preforms produced during the same injection cycle. In this way, processing of preforms within a particular cycle is substantially identical.

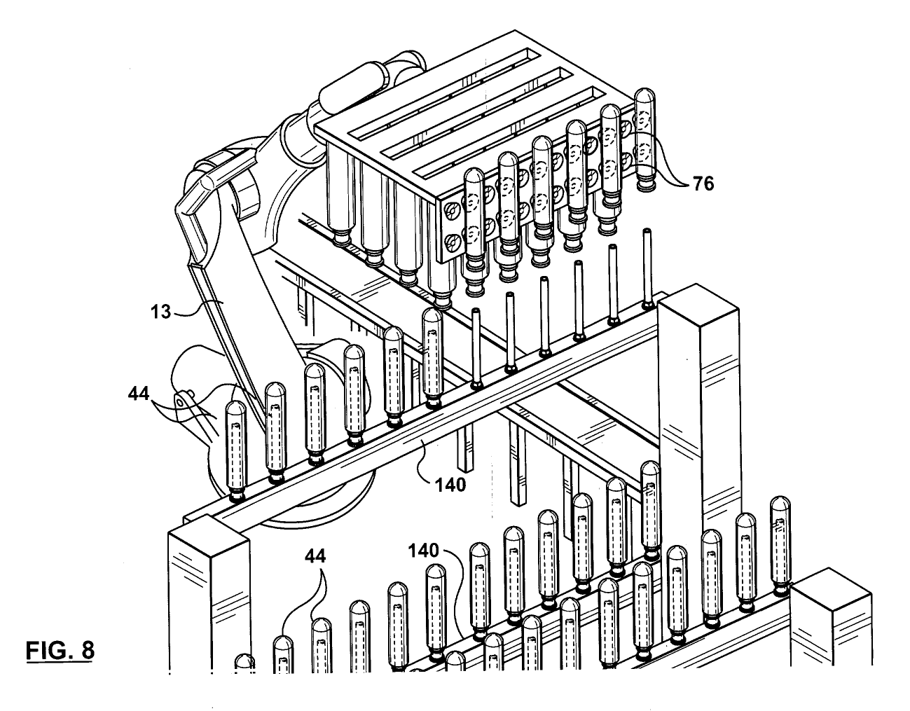

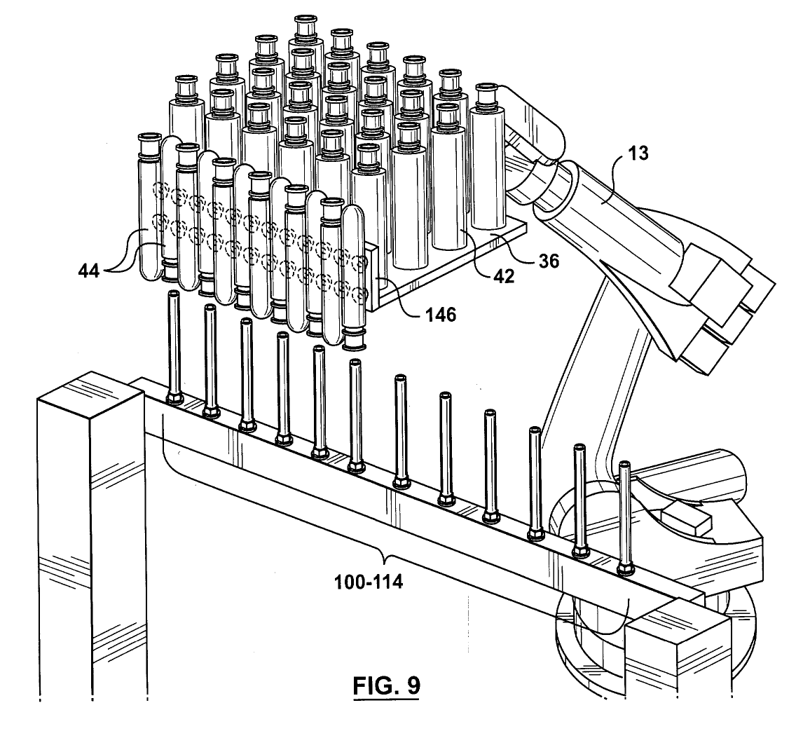

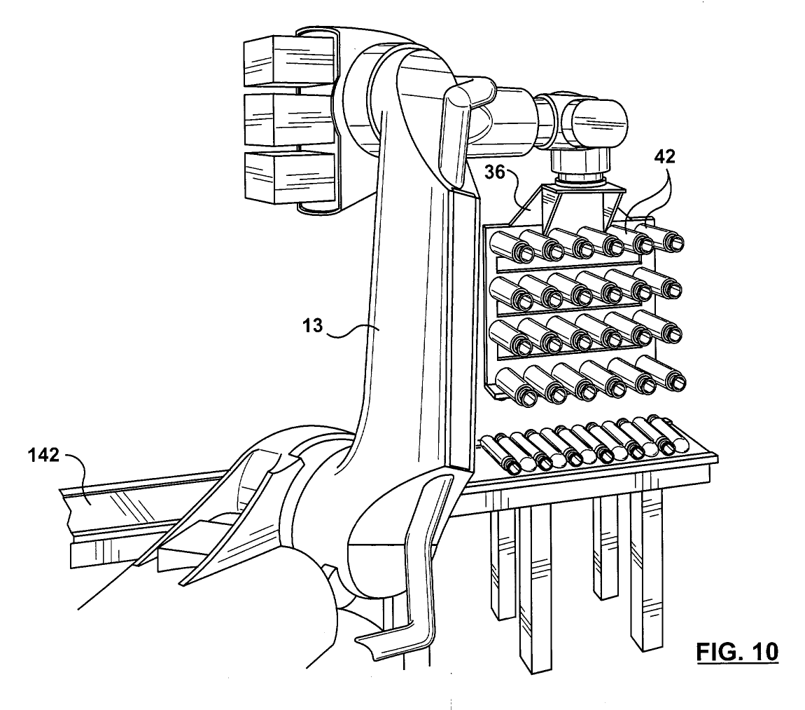

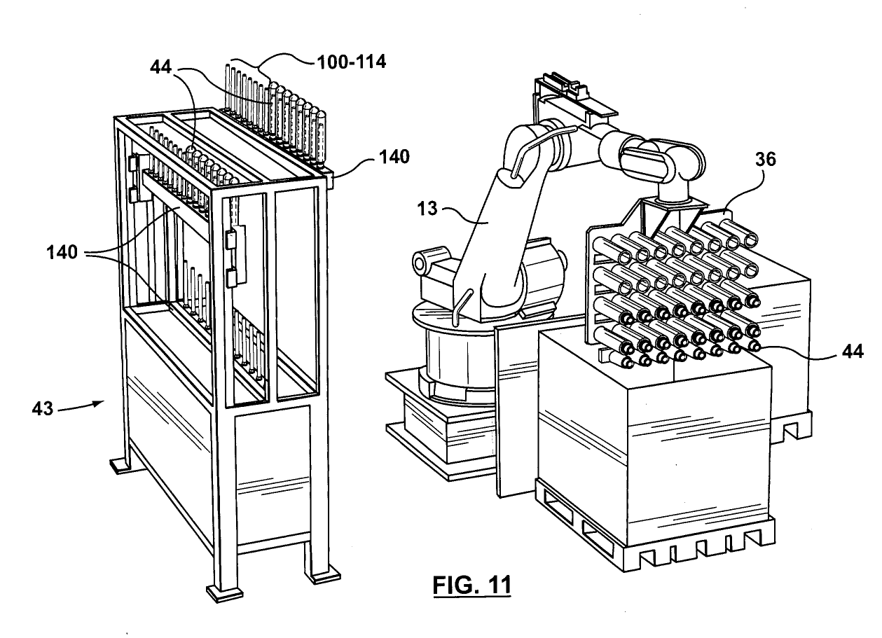

Turning to FIG. 8, a first set of preforms (now located on some of the upstanding pins) is engaged by the suction function supported by the suction cups 76 of the multi-function take-out plate. Specifically, re-positioning of the robot arm and hence the take-out plate 36 causes alignment of the suction cups 76 along the body of adjacently located preforms. By applying the vacuum to those aligned suction cups 76, the preforms are secured into/against the suction cups 76, thereby permitting those preforms to be lifted from the pins 100-114 upon upward movement of the robot arm and take-out plate 36; this is shown in FIG. 8. Movement of the robot (and hence the take-out plate 36), preferably including axial rotation of the take-out plate 36, permits further alignment of presently empty suction cups 76 with a second set of preforms held on the rack 140. Controlled lowering of the take-out plate 36 permits the aligned preforms to be further aligned suction cups 76, whereupon applied suction permits this second set of preforms to be temporarily and selectively secured to the multi-position take-out plate 36. The robot arm can then be withdrawn (see FIG. 9) and re-orientated into an appropriate place or drop location (FIG. 10) where the preforms (held on the suction cups, or the like) can be deposited to allow the entire cyclic process to start over. The preforms can be placed, for example, on a conveyor 142 (of FIG. 10), or otherwise loaded into a crate 144 (of FIG. 11).

In essence, once a first set of performs is removed from the rack of pins onto the suction cups of the take-out plate, the robot is moved to allow pick up of a second set of preforms that are then interleaved with those preforms already temporarily held by the suction cups 76. In this way, the pitch separation between adjacent preforms is reduced on the take-out plate (when compared against the pitch separation between adjacent preforms in the mold).

Preferably, when located on a rack 140 having vertically projecting pins, the tips of the pins are displaced from the domed end portions or gate regions of the preforms (or molded articles), whereby the neck regions of the preforms are used to support the preforms. Preferably, with aggressive cooling of the preforms in the take-out plate, the neck regions are sufficiently solidified to avoid any surface deformation caused by contact with a base of the rack (or other support ledge from which an individual pin projects). Cooling of the neck of the preform can be achieved either as a consequence of the preforms being retained in the take-out plate for more than one cycle (through the use of a multi-position take-out plate) or simply by virtue of the fact that the preform is retained for the relatively long duration associated with the molding of a heavyweight preform. The pins are also preferably hollow and support the expulsion of cooling fluid from their respective tips. Hence, the rack 140 may be, as appropriate, connected to a switchable cooling fluid supply/vacuum supply as described hereinbefore.

The take-out plate may support individual tubes that are individually cooled by a cooling circuit flowing therethrough, or the tubes can be cooled by effective location into a heat sink, e.g. a fluid (and preferably liquid) cooled base plate to which the individual (take-out) tubes are mechanically coupled.

To account for the successive placement of sets of preforms into the crate 74, the handling robot 13 can be fitted with an optical or pressure sensor (not shown) to ensure soft placement of sets of preforms either in successive layers and/or side-by-side.

While the head-to-toe packing of adjacent preforms provides an optimum solution that address the problem of curvature and, more generally, the varying diameter of heavyweight preforms in a transit packing environment, it is perceived that the present invention may extend to sub-optimal systems in which, for example, two adjacent heavyweight preforms are orientated identically, whereas the next adjacent pair of heavyweight preforms are orientated in an opposite (180° reversed) direction to mitigate the aforementioned curvature and diameter issues arising with transit packing of such large preforms.

With respect to implementation of the multi-function take-out plate, the additional suction functionality can be applied retrospectively to an existing plate through the provision of a complementary bolt-on side panel 146 or panels. Alternatively, the ancillary suction function can be supplied in a customer, integrally manufactured plate environment.

The number of pick-up holders or adhesion points assigned to engage the outer surface of molded article may be the same, more or fewer than the number of articles formed during a single injection cycle. Indeed, it is perceived that situations may arise when the robot deposits preforms (formed during a single injection cycle) onto pins of a rack in such a way that the robot is repeatedly operated (in two or more steps) to pick-up the preforms using the suction cups (or their functional equivalent) to manipulate all preforms formed in a single injection cycle. Putting this a different way, it is perceived that there could be fewer pins than molded articles formed during a single injection cycle, or that the number of molded articles formed during an injection cycle would warrant deposition of preforms onto multiple racks, e.g. to save space. The multi-function take-out plate, and its cooperation (in use) with programmed robotic movement, in all instances allows effective part manipulation for packing purposes, since the suction cups preform an independent but complementary function associated in the overall removal and packing process. It may, as shown in FIG. 5, also be necessary to provide more than one adhesion point, i.e. multiple suction cups, for the preform to be selectively attached to the take-out plate, thereby ensuring stable transfer of the molded article when located on the take-out plate 36.

The take-out plate 36 may contain one or more regions where adhesion points/suction cups 76 are placed, with the previous description being exemplary of the concept. The provision of more than one side panel (or the like) supporting the suction cups 76 arises from constraints imposes by the overall physical dimensions of the preforms. Although it is preferably, from a space perspective, to locate the adhesion points on an abutting side plate that extends from a frame that supports the cooling tubes (or take-out holders) 42, the adhesion points could be located on a rear surface of the frame (i.e. the surface opposite the surface from which the cooling tubes are fixed and project). To reduce weight, the frame and indeed the entire take-out plate is preferably made from a lightweight material, such as aluminium, although steel would also be acceptable. Furthermore, the take-out plate 36, in its entirety, can be made from a framework of interconnected plates, rather than a solid structure.

In a retrofit environment, the side panels supporting the adhesion points may include integrally machined channels to support interconnection to a vacuum supply, alternatively a simplified tubing mechanism may be provided to each adhesion point.

It will of course be understood that, although the above description is concerned with the handling and packing of multiple, large or heavyweight preforms produced in a single cycle, the system of the present invention is applicable to the handling of smaller preforms and, indeed, any molded elongate articles that are physically dimensioned to an extend where efficient and/or damage-free transit packing is encountered when employing a randomly orientated packing philosophy. Also, while the preferred embodiment of FIG. 3 has been described in relation to a two parallel receiving plate system, the present invention can be extended to multiple parallel receiving plates to accommodate take-out plate layouts and differing mold cavitation configurations. It is further recognized that the novel construction of the multi-function take-out plate is such that a benefit can be derived even without supporting a reduction in pitch separation provided by close-packing of the adhesion points.

What is claimed is:

1. A multi-function take-out plate comprising:
a plurality of holders each arranged, in use, to receive a molded article formed in and extracted from a respective cavity of a mold; and
a plurality of selectively engagable adhesion points arranged along the take-out plate, the adhesion points configured, in use, to pick up and temporarily hold linear arrays of molded articles for subsequent delivery and deposition.

2. The multi-position take-out plate according to claim 1, wherein the plurality of holders have a first pitch separation corresponding to a first pitch separation from the mold from which, in use, the molded articles would be extracted and the adhesion points arranged in an array that causes, in use, molded articles held by the adhesion points to have a reduced pitch separation between adjacent injection molded articles relative to the first pitch separation in the mold.

3. The multi-function take-out plate according to claim 2, wherein the holders are cooling tubes.

4. The multi-function take-out plate according to claim 3, wherein the cooling tubes are individually cooled.

5. The multi-function take-out plate according to claim 3, wherein the cooling tubes are mechanically coupled to a heat sink through which cooling is effected.

6. The multi-function take-out plate according to claim 2, wherein the take-out plate includes at least two sets of holders, each set of holders capable of holding all molded articles formed during a single molding cycle.

7. The multi-function take-out plate according to claim 2, wherein the adhesion points are realized as suction cups coupled, in use, to a vacuum system.

8. The multi-function take-out plate according to claim 2, wherein there are a corresponding number of adhesion points to molded articles formed during a single injection molding cycle.

9. The multi-function take-out plate according to claim 2, wherein the take-out comprising:
a base plate to which, in use, the plurality of holders is attached; and
a secondary plate including the adhesion points, the secondary plate coupled to the base plate and extending substantially perpendicular to the base plate.

10. The multi-function take-out plate according to claim 9, wherein the secondary plate is detachable from the base plate.

11. The multi-function take-out plate according to claim 9, wherein the secondary plate is a retrofitted plate.

12. The multi-function take-out plate according to claim 11, wherein the retrofitted plate includes one of:
integrally formed channeling to support vacuum connection; and
a tubing network coupled to each adhesion point.

13. The multi-function take-out plate according to claim 2, wherein the adhesion points are located on the base plate.

14. The multi-function take-out plate according to claim 2, wherein the adhesion points are integrally formed in the base plate.

15. A multi-function take-out plate comprising:
a base plate having a first surface and a side surface, the first surface having located thereon a plurality of cooling tube connection points, each cooling tube connection point arranged, in use, to mount a cooling tube configured to receive a molded article; and
at least one side plate coupled to a surface of the base plate, the side plate having at least one selectively engagable molded article adhesion point, the at least one adhesion point supporting, in use, pick up and temporarily retain a linear array of molded articles for subsequent delivery and deposition thereof.

16. The multi-position take-out plate according to claim 15, wherein the plurality of cooling tube connection points are located such as to allow, in use, the cooling tubes to have a first pitch separation corresponding to a first pitch separation from a mold from which, in use, the molded articles would be extracted; and the at least one adhesion points arranged in an array that causes, in use, molded articles held at the adhesion points to have a reduced pitch separation between adjacent injection molded articles relative to the first pitch separation in the mold.

17. The multi-function take-out plate according to claim 16, wherein the at least one adhesion point each have a suction cup coupled thereto.

18. The multi-function take-out plate according to claim 17, wherein each of the at least one adhesion point supports multiple suction cups.

19. A side panel for connecting to a take-out plate, the side panel including at least one selectively engagable adhesion point, the at least one adhesion point configured, in use, to pick up and temporarily hold at least one molded article for subsequent delivery and deposition.

20. The side panel according to claim 19, wherein the at least one adhesion point are arranged in an array that causes, in use, molded articles held by the at least one adhesion point to have a reduced pitch separation between adjacent injection molded articles relative to a pitch separation of the molded article within a mold.

21. The side panel according to claim 19, including one of:
integrally formed channeling to support vacuum connection; and
a tubing network coupled to each adhesion point.

22. The side panel according to claim 21, including means for attaching the side panel to a take-out plate.
